(19) United States
(12) Patent Application Publication
(10) Pub. No.: US 2025/0370631 A1
(43) Pub. Date: Dec. 4, 2025

(54) MEMORY SUB-SYSTEM FOR ALLOCATING BLOCK STRIPES BASED ON PROGRAM ERASE CYCLES

(71) Applicant: Micron Technology, Inc., Boise, ID (US)

(72) Inventors: Paul Roger Stonelake, Kihei, HI (US); Byron D. Harris, Mead, CO (US); Noorshaheen Mavungal Noorudheen, Longmont, CO (US)

(21) Appl. No.: 19/219,941

(22) Filed: May 27, 2025

Related U.S. Application Data
(60) Provisional application No. 63/652,297, filed on May 28, 2024.

(51) Int. Cl. G06F 3/06

(52) U.S. Cl. CPC G06F 3/0616; G06F 3/0608; G06F 3/0631; G06F 3/0652; G06F 3/0659; G06F 3/0679

(57) ABSTRACT

Various aspects of the present disclosure relate to a memory sub-system for allocating block stripes based on program erase cycles. A processing device may access a plurality of block stripes and may determine a program erase cycle count for each block stripe of the plurality of block stripes. The processing device may designate a first block stripe of the plurality of block stripes as a cache memory block stripe based on first block stripe having a lower program erase cycle count and may designate a second block stripe of the plurality of block stripes as an FTL block stripe based on the second block stripe having a higher program erase cycle count.

### RELATED APPLICATIONS

This application claims the benefit of U.S. Provisional Patent Application No. 63/652,297, filed May 28, 2024, the entire contents of which are hereby incorporated by reference here.

### TECHNICAL FIELD

Aspects of the disclosure relate generally to memory sub-systems, and more specifically, to a memory sub-system for allocating block stripes based on program erase cycles.

### BACKGROUND

A memory sub-system can include one or more memory devices that store data. The memory devices can be, for example, non-volatile memory devices and volatile memory devices. In general, a host system can utilize a memory sub-system to store data at the memory devices and to retrieve data from the memory devices.

### BRIEF DESCRIPTION OF THE DRAWINGS

The present disclosure will be understood more fully from the detailed description given below and from the accompanying drawings of various aspects of the disclosure.

FIG. 1 illustrates an example computing system that includes a memory sub-system, in accordance with some aspects of the present disclosure.

FIG. 2 is a sequence diagram illustrating an example method of allocating block stripes based on program erase cycles, in accordance with some aspects of the present disclosure.

FIG. 3 is a sequence diagram illustrating an example method of programming and erasing block stripes based on block stripe allocations, in accordance with some aspects of the present disclosure.

FIG. 4 is a flow diagram of an example method of allocating block stripes based on program erase cycles, in accordance with some aspects of the present disclosure.

FIG. 5 is a block diagram of an example computer system in which some aspects of the present disclosure may operate.

### DETAILED DESCRIPTION

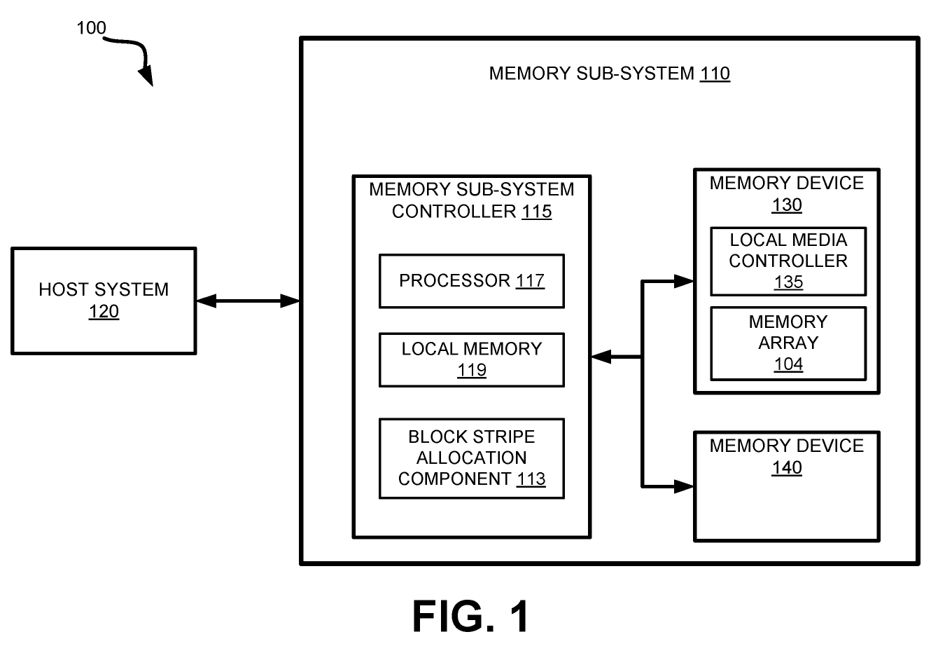

Aspects of the present disclosure are directed to a memory sub-system for allocating block stripes based on program erase cycles. A memory sub-system can be a storage device, a memory module, or a combination of a storage device and memory module. Examples of storage devices and memory modules are described below in conjunction with FIG. 1. In general, a host system can utilize a memory sub-system that includes one or more components, such as memory devices that store data. The host system can provide data to be stored at the memory sub-system and can request data to be retrieved from the memory sub-system.

A memory sub-system can include high density non-volatile memory devices where retention of data is desired when no power is supplied to the memory device. One example of non-volatile memory devices is a not-and (NAND) memory device. Other examples of non-volatile memory devices are described below in conjunction with FIG. 1. A non-volatile memory device is a package of one or more dies. Each die can include one or more planes. For some types of non-volatile memory devices (e.g., NAND devices), each plane includes of a set of physical blocks. Each block includes of a set of pages. Each page includes of a set of memory cells (“cells”). A cell is an electronic circuit that stores information. Depending on the cell type, a cell can store one or more bits of binary information, and has various logic states that correlate to the number of bits being stored. The logic states can be represented by binary values, such as “0” and “1”, or combinations of such values.

A memory device can include multiple memory cells arranged in a two-dimensional or a three-dimensional grid. Memory cells are formed onto a silicon wafer in a rectangular array; the memory cells may be joined by conductive lines referred to as wordlines and bitlines. The intersection of a bitline and wordline constitutes the address of the memory cell. A block hereinafter refers to a unit of the memory device used to store data and can include a group of memory cells, a wordline group, a wordline, or individual memory cells. One or more blocks can be grouped together to form separate partitions (e.g., planes) of the memory device in order to allow concurrent operations to take place on each plane. The memory device can include circuitry that performs concurrent memory page accesses of two or more memory planes. For example, the memory device can include multiple access line driver circuits and power circuits that can be shared by the planes of the memory device to facilitate concurrent access of pages of two or more memory planes, including different page types. For ease of description, these circuits can be generally referred to as independent plane driver circuits. Depending on the storage architecture employed, data can be stored across the memory planes (i.e., in stripes). Accordingly, one request to read a segment of data (e.g., corresponding to one or more data addresses), can result in read operations performed on two or more of the memory planes of the memory device.

A memory device may include different types of memory distributed across multiple portions of the memory device. Data at one portion of the memory (for example, the NAND memory) may be arranged according to a file system. A file system is a data structure that can be used by the memory sub-system to control how data is stored and retrieved. For example, the file system may organize data into files and directories in order to allow users and applications to store and retrieve data efficiently. Another portion of the NAND memory may include single-level cell (SLC) memory. In SLC memory, each memory cell stores a single bit of data. SLC memory may have high-speed, high-durability, and low power-consumption compared to other types of memory, but at a higher cost per-bit of storage. Another portion of the NAND memory may include multi-level cell (MLC) memory. MLC memory stores multiple bits of data per memory cell, which allows for higher storage density and lower cost per bit compared to SLC memory. One example type of MLC memory is quad-level cell (QLC) memory which stores four bits of data per memory cell. However, MLC memory has slower write speeds and lower endurance because of the complexity of managing more bits per cell. Another portion of the memory may include flash translation layer (FTL) memory. FTL memory is firmware layer memory that can be used to map logical block addresses (LBA) to physical block addresses on the memory device. FTL memory may be used for managing wear leveling and garbage collection operations, among other examples.

Writing data to a memory cell may include applying a voltage to the memory cell, causing a state of the memory cell to change. For example, in SLC memory, each memory cell holds a single bit, where charged cells represent 0 and uncharged cells represent 1 (or vice versa). Erasing the data may include removing the charge from the cells, resetting them to a baseline state. The process of writing data to the memory cells and erasing the data from the memory cell is referred to as a program erase cycle (PEC). Each PEC of a memory cell causes a slight physical degradation of the memory cell due to the stress of applying and removing charges. This wear and tear can accumulate over time. Memory cells have a limited number of program erase cycles they can endure before becoming unreliable. Therefore, the endurance of a memory device can be expressed in terms of the number of program erase cycles it is able to withstand. In some cases, program erase cycles may be managed at a block stripe level. A block stripe may include multiple data blocks that are spread across multiple dies (for example, all dies) of the memory device. In this case, the endurance of a memory device can be defined by a maximum number of program erase cycles for the block stripes of the memory device.

SLC memory may divided into cache memory and FTL memory. A larger portion of block stripes in the SLC memory may be allocated to the cache memory for data storage and a smaller portion of block stripes in the SLC memory may be allocated to the FTL memory for metadata storage (such as mapping table and power loss information storage). In an example SLC memory that includes one hundred block stripes, ninety block stripes may be allocated to the cache memory and ten block stripes may be allocated to the FTL memory. However, cache data may be programmed more frequently than FTL data. For example, cache data may be programmed eight times more frequently, or one hundred times more frequently, than FTL data. This may cause the cache memory block stripes to reach a maximum PEC count faster than the FTL block stripes. At that point, the memory device may need to be discarded. However, the memory device may include a number of FTL block stripes that have not reached the maximum PEC count. This may result in the memory device being discarded before some of the block stripes of the memory device have reached the maximum PEC count.

Aspects of the present disclosure address the above and other deficiencies by providing a memory sub-system for allocating block stripes based on program erase cycles. In some aspects, a memory sub-system controller associated with the memory sub-system may determine a PEC count for multiple block stripes. Each block stripe of the multiple block stripes may span multiple dies (for example, all dies) of the memory device and may not include any valid data. The memory sub-system controller may designate the block stripes to be used for different types of memory based on the corresponding PEC counts of the block stripes. For example, the memory sub-system controller may designate a first block stripe as a cache memory block stripe and may designate a second block stripe as an FTL block stripe based on the PEC count of the first block stripe being lower than the PEC count of the second block stripe. In some aspects, the memory sub-system controller may sort the block stripes into a list of block stripes ordered from a lowest PEC count to a highest PEC count, may assign a first set of one or more block stripes having the lowest PEC count to be used as cache memory block stripes, and may assign a second set of one or more block stripes having a next lowest PEC count to be used as FTL block stripes. The memory sub-system controller may write data to the block stripes based on the respective designations of the block stripes. For example, the memory sub-system controller may write data to the one or more block stripes designated as cache memory block stripes and may write metadata to the one or more other block stripes designated as FTL block stripes. In some cases, data in the cache memory block stripes and the FTL block stripes may become invalid. For example, the block stripes may include data that has been re-written by a host device or that has otherwise been indicated as no longer being needed. The memory sub-system controller may perform garbage collection for the block stripes and may erase all data and metadata included in the block stripes. Erasing the data and metadata from the block stripes may remove the respective designations of the block stripes. Therefore, the block stripes may be assigned to the same block stripe pool and may be re-designated as cache clock stripes or FTL block stripes based on the respective PEC counts of the block stripes.

Some advantages of the present disclosure include improving a lifespan of a memory device. For example, designating block stripes having lower PEC counts as cache memory block stripes and designating block stripes having higher PEC counts as FTL block stripes may allow the PEC counts of the block stripes to be exploited prior to the memory device being discarded. Some advantages of the present disclosure include enabling block stripes to be re-designated based on the PEC counts of the block stripes. For example, a block stripe previously designated as a cache memory block stripe, and after being erased, may be re-designated as a cache memory block stripe (based on the block stripe having a lower PEC count than other available block stripes) or as an FTL block stripe (based on the block stripe having a higher PEC count than other available block stripes). Similarly, a block stripe previously designated as an FTL block stripe, and after being erased, may be re-designated as an FTL block stripe (based on the block stripe having a higher PEC count than other available block stripes) or as a cache memory block stripe (based on the block stripe having a lower PEC count than other available block stripes). Some advantages of the present disclosure may enable cache memory block stripes and FTL block stripes to share a common garbage pool and a common erase pool. This may increase a flexibility of the memory device and may enable all block stripes (regardless of designation) to be sorted based on respective PEC counts. These example advantages, among others, are described in more detail below.

FIG. 1 illustrates an example computing system 100 that includes a memory sub-system 110, in accordance with some aspects of the present disclosure. The memory sub-system 110 can include media, such as one or more volatile memory devices (e.g., memory device 140), one or more non-volatile memory devices (e.g., one or more memory device(s) 130), or a combination of such.

The memory sub-system 110 can be a storage device, a memory module, or a hybrid of a storage device and memory module. Examples of a storage device include a solid-state drive (SSD), a flash drive, a universal serial bus (USB) flash drive, an embedded Multi-Media Controller (eMMC) drive, a Universal Flash Storage (UFS) drive, a secure digital (SD) card, and a hard disk drive (HDD). Examples of memory modules include a dual in-line memory module (DIMM), a small outline DIMM (SO-DIMM), and various types of non-volatile dual in-line memory modules (NVDIMMs).

The computing system 100 can be a computing device such as a desktop computer, laptop computer, network server, mobile device, a vehicle (e.g., airplane, drone, train, automobile, or other conveyance), Internet of Things (IoT) enabled device, embedded computer (e.g., one included in a vehicle, industrial equipment, or a networked commercial device), or such computing device that includes memory and a processing device.

The computing system 100 can include a host system 120 that is coupled to one or more memory sub-systems 110. In some aspects, the host system 120 is coupled to different types of memory sub-system 110. FIG. 1 illustrates one example of a host system 120 coupled to one memory sub-system 110. As used herein, “coupled to” or “coupled with” generally refers to a connection between components, which can be an indirect communicative connection or direct communicative connection (e.g., without intervening components), whether wired or wireless, including connections such as electrical, optical, magnetic, etc.

The host system 120 can include a processor chipset and a software stack executed by the processor chipset. The processor chipset can include one or more cores, one or more caches, a memory controller (e.g., NVDIMM controller), and a storage protocol controller (e.g., PCIe controller, SATA controller, CXL controller). The host system 120 uses the memory sub-system 110, for example, to write data to the memory sub-system 110 and read data from the memory sub-system 110.

The host system 120 can be coupled to the memory sub-system 110 via a physical host interface. Examples of a physical host interface include a serial advanced technology attachment (SATA) interface, a compute express link (CXL) interface, a peripheral component interconnect express (PCIe) interface, universal serial bus (USB) interface, Fibre Channel, Serial Attached SCSI (SAS), a double data rate (DDR) memory bus, Small Computer System Interface (SCSI), a dual in-line memory module (DIMM) interface (e.g., DIMM socket interface that supports Double Data Rate (DDR)), etc. The physical host interface can be used to transmit data between the host system 120 and the memory sub-system 110. The host system 120 can further utilize an NVM Express (NVMe) interface to access the memory components (e.g., the one or more memory device(s) 130) when the memory sub-system 110 is coupled with the host system 120 by the physical host interface (e.g., PCIe or CXL interface). The physical host interface can provide an interface for passing control, address, data, and other signals between the memory sub-system 110 and the host system 120. FIG. 1 illustrates a memory sub-system 110 as an example. In general, the host system 120 can access multiple memory sub-systems via a same communication connection, multiple separate communication connections, and/or a combination of communication connections.

The memory devices 130, 140 can include any combination of the different types of non-volatile memory devices and/or volatile memory devices. The volatile memory devices (e.g., memory device 140) can be random access memory (RAM), such as dynamic random access memory (DRAM) and synchronous dynamic random access memory (SDRAM).

Some examples of non-volatile memory devices (e.g., memory device(s) 130) include negative-and (NAND) type flash memory and write-in-place memory, such as three-dimensional cross-point (“3D cross-point”) memory. A cross-point array of non-volatile memory can perform bit storage based on a change of bulk resistance, in conjunction with a stackable cross-gridded data access array. Additionally, in contrast to many flash-based memories, cross-point non-volatile memory can perform a write in-place operation, where a non-volatile memory cell can be programmed without the non-volatile memory cell being previously erased. NAND type flash memory includes, for example, two-dimensional NAND (2D NAND) and three-dimensional NAND (3D NAND).

Each of the memory device(s) 130 can include one or more arrays of memory cells. One type of memory cell, for example, single level cells (SLC) can store one bit per cell. Other types of memory cells, such as multi-level cells (MLCs), triple level cells (TLCs), and quad-level cells (QLCs), can store multiple bits per cell. In some aspects, each of the memory devices 130 can include one or more arrays of memory cells such as SLCs, MLCs, TLCs, QLCs, or any combination of such. In some aspects, a particular memory device can include an SLC portion, and an MLC portion, a TLC portion, or a QLC portion of memory cells. The memory cells of the memory devices 130 can be grouped as pages that can refer to a logical unit of the memory device used to store data. With some types of memory (e.g., NAND), pages can be grouped to form blocks.

Although non-volatile memory components such as a 3D cross-point array of non-volatile memory cells and NAND type flash memory (e.g., 2D NAND, 3D NAND) are described, the memory device 130 can be based on any other type of non-volatile memory, such as read-only memory (ROM), phase change memory (PCM), self-selecting memory, other chalcogenide based memories, ferroelectric transistor random-access memory (FeTRAM), ferroelectric random access memory (FeRAM), magneto random access memory (MRAM), Spin Transfer Torque (STT)-MRAM, conductive bridging RAM (CBRAM), resistive random access memory (RRAM), oxide based RRAM (OxRAM), negative-or (NOR) flash memory, electrically erasable programmable read-only memory (EEPROM).

A memory sub-system controller 115 (or controller 115 for simplicity) can communicate with the memory device(s) 130 to perform operations such as reading data, writing data, or erasing data at the memory devices 130 and other such operations. The memory sub-system controller 115 can include hardware such as one or more integrated circuits and/or discrete components, a buffer memory, or a combination thereof. The hardware can include a digital circuitry with dedicated (i.e., hard-coded) logic to perform the operations described herein. The memory sub-system controller 115 can be a microcontroller, special purpose logic circuitry (e.g., a field programmable gate array (FPGA), an application specific integrated circuit (ASIC), etc.), or other suitable processor.

The memory sub-system controller 115 can include a processor 117 (e.g., a processing device) configured to execute instructions stored in a local memory 119. In the illustrated example, the local memory 119 of the memory sub-system controller 115 includes an embedded memory configured to store instructions for performing various processes, operations, logic flows, and routines that control operation of the memory sub-system 110, including handling communications between the memory sub-system 110 and the host system 120.

In some aspects, the local memory 119 can include memory registers storing memory pointers, fetched data, etc. The local memory 119 can also include read-only memory (ROM) for storing micro-code. While the example memory sub-system 110 in FIG. 1 has been illustrated as including the memory sub-system controller 115, in some other aspects, a memory sub-system 110 does not include a memory sub-system controller 115, and can instead rely upon external control (e.g., provided by an external host, or by a processor or controller separate from the memory sub-system).

In general, the memory sub-system controller 115 can receive commands or operations from the host system 120 and can convert the commands or operations into instructions or appropriate commands to achieve the desired access to the memory device(s) 130. The memory sub-system controller 115 can be responsible for other operations such as wear leveling operations, garbage collection operations, error detection and error-correcting code (ECC) operations, encryption operations, caching operations, and address translations between a logical address (e.g., logical block address (LBA), namespace) and a physical address (e.g., physical block address) that are associated with the memory device(s) 130. The memory sub-system controller 115 can further include host interface circuitry to communicate with the host system 120 via the physical host interface. The host interface circuitry can convert the commands received from the host system into command instructions to access the memory device(s) 130 as well as convert responses associated with the memory device(s) 130 into information for the host system 120.

The memory sub-system 110 can also include additional circuitry or components that are not illustrated. In some aspects, the memory sub-system 110 can include a cache or buffer (e.g., DRAM) and address circuitry (e.g., a row decoder and a column decoder) that can receive an address from the memory sub-system controller 115 and decode the address to access the memory device(s) 130.

In some aspects, the memory device(s) 130 include local media controllers 135 that operate in conjunction with memory sub-system controller 115 to execute operations on one or more memory cells of the memory device(s) 130. An external controller (e.g., memory sub-system controller 115) can externally manage the memory device 130 (e.g., perform media management operations on the memory device(s) 130). In some aspects, a memory device 130 is a managed memory device, which is a raw memory device (e.g., memory array 104) having control logic (e.g., local controller 135) for media management within the same memory device package. An example of a managed memory device is a managed NAND (MNAND) device. Memory device(s) 130, for example, can each represent a single die having some control logic (e.g., local media controller 135) embodied thereon. In some aspects, one or more components of memory sub-system 110 can be omitted.

In some aspects, the memory sub-system 110 includes a block stripe allocation component 113 that can be used to allocate block stripes to certain types of memories based on program erase cycle counts of the block stripes. For example, the block stripe allocation component 113 may access multiple block stripes that do not include any data and may determine a program erase cycle count for each block stripe of the multiple block stripes. The block stripe allocation component 113 may designate a first block stripe of the multiple block stripes as a first type of block stripe based on a corresponding program erase cycle count of the first block stripe, and may designate a second block stripe of the multiple block stripes as a second type of block stripe based on a corresponding program erase cycle count of the second block stripe, where the corresponding program erase cycle count of the second block stripe is greater than the corresponding program erase cycle count of the first block stripe. For example, the block stripe allocation component 113 may designate a first block stripe having a lower program erase cycle count as a cache memory block stripe and may designate a second block stripe having a higher program erase cycle count as a flash translation layer block stripe. Additional details regarding these features are described below.

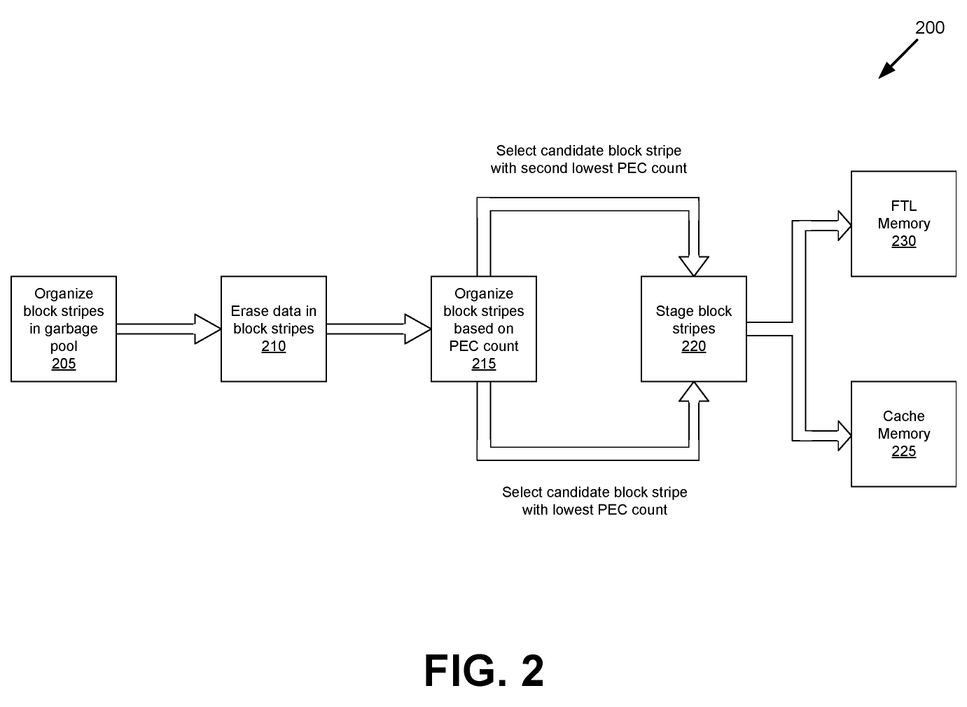

FIG. 2 is a sequence diagram of an example method 200 of allocating block stripes based on program erase cycles, in accordance with some aspects of the present disclosure. The method 200 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some aspects, the method 200 is performed by the block stripe allocation component 113 of FIG. 1. Although shown in a particular sequence or order, unless otherwise specified, the order of the processes can be modified. Thus, the illustrated aspects should be understood only as examples, and the illustrated processes can be performed in a different order, and some processes can be performed in parallel. Additionally, one or more processes can be omitted in various aspects. Thus, not all processes are required in every aspect. Other process flows are possible.

As described herein, a memory device may include QLC block stripes and SLC block stripes. The SLC block stripes may be divided between FTL block stripes and cache memory block stripes. A large portion of the block stripes may be QLC block stripes (data band block stripes), while a small portion of the block stripes may be SLC block stripes. In one example, ninety-four percent of the block stripes may be QLC block stripes and six percent of the block stripes may be SLC block stripes. The processing logic may allocate the SLC block stripes between the cache memory and the FTL. For example, the processing logic may allocate five percent of the block stripes to the cache memory and may allocate one percent of the block stripes to the FTL. Therefore, allocating the block stripes to the cache memory or the FTL (for example, designating the block stripes as cache memory block stripes or FTL block stripes) may refer only to the SCL block stripes, and may not refer to the QLC block stripes.

At operation 205, the processing logic (e.g., the block stripe allocation component 113) organizes block stripes. The block stripes may be included in (or otherwise associated with) a garbage pool. The garbage pool may be a common garbage pool that includes multiple block stripes associated with different types of memories. For example, the garbage pool may include at least one block stripe associated with a first type of memory (such as a cache memory block stripe) and may include at least one block stripe associated with a second type of memory (such as an FTL block stripe). In some aspects, each block stripe in the garbage pool may be designated as a first type of block stripe that is programmed at a higher programming rate or as a second type of block stripe that is programmed at a lower programming rate. For example, each block stripe may be designated as a cache memory block stripe (programmed at the higher rate) or an FTL block stripe (programmed at the lower rate). The processing logic may organize the plurality of block stripes based on respective PEC counts of the block stripes. For example, the processing logic may sort the block stripes into a list of block stripes, where a first block stripe in the list of block stripes has a lowest PEC count of the block stripes and a last block stripe in the list of block stripes has a highest PEC count of the block stripes.

At operation 210, the processing logic erases data stored in the block stripes. At least some of the data included in the block stripes may be invalid data. The processing logic may erase the data stored in the block stripes, for example, by setting each bit in the block stripe to zero. Erasing the data in the block stripes may include erasing a designation of the block stripes as first types of block stripes or second types of block stripes. For example, the processing logic may erase all of the data in one or more cache memory block stripes, thereby changing the designation of the one or more cache memory block stripes to non-designated block stripes (block stripes not associated with a particular type of memory). Additionally, the processing logic may erase all of the data in one or more FTL stripes, thereby changing the designation of the one or more FTL block stripes to non-designated block stripes.

At operation 215, the processing logic organizes the block stripes based on respective PEC counts of the block stripes. For example, the processing logic organizes the non-designated block stripes (which may also be referred to as free block stripes) based on respective PEC counts of the block stripes. In some aspects, the processing logic may sort the block stripes into a list of block stripes, where a first block stripe in the list of block stripes has a lowest PEC count of the block stripes and a last block stripe in the list of block stripes has a highest PEC count of the block stripes.

At operation 220, the processing logic stages the block stripes. Staging the block stripes may include assigning the block stripes to one or more types of memory based on respective PEC counts of the block stripes. For example, staging a block stripe may include assigning the block stripe to a first type of memory or a second type of memory based on a PEC count of the block stripe, where the first type of memory and the second type of memory are programmed at different rates. The block stripe may be assigned to the first type of memory (having the higher programming rate) based on the block stripe having a lower PEC count or may be assigned to the second type of memory (having the lower programming rate) based on the block stripe having a higher PEC count. In some aspects, staging the block stripes may include setting a flag associated with the block stripe to a first value (for example, 0) or a second value (for example, 1), where the first value indicates that the block stripe is associated with the first type of memory and the second value indicates that the block stripe is associated with the second type of memory.

In some aspects, staging the block stripes may include assigning the block stripes to cache memory 225 or FTL memory 230. For example, staging the block stripes may include designating a first block stripe as a cache memory block stripe based on the block stripe having a lower PEC count and designating a second block stripe as an FTL block stripe based on the block stripe having a higher PEC count. In some aspects, the processing logic may select candidate block stripes (e.g., free block stripes) to be assigned to the cache memory 225 or the FTL memory 230. For example, the processing logic may select a first candidate block stripe (or multiple first candidate block stripes) from the list of block stripes having the lowest PEC count in the list of block stripes and may assign the first candidate block stripe to the cache memory 225, and may select a second candidate block stripe (or multiple second candidate block stripes) from the list of block stripes having the second lowest PEC count in the list of block stripes and may assign the second candidate block stripe to the FTL memory 230. As described herein, cache memory block stripes may be programmed more frequently than FTL block stripes. Therefore, it may be beneficial for block stripes having a lower PEC count to be assigned to be used by the cache memory and for block stripes having a higher PEC count to be assigned to be used by the FTL memory, which may increase a longevity of the memory device.

In some aspects, designating the first block stripe as the cache memory block stripe includes designating a first quantity of block stripes from the list of block stripes as cache memory block stripes. Similarly, designating the second block stripe as the flash translation layer block stripe includes designating a second quantity of block stripes in the list of block stripes as flash translation layer block stripes. The first quantity of block stripes and the second quantity of block stripes may be based on a block stripe resource allocation parameter. The block stripe resource allocation parameter may indicate a quantity of block stripes (or a percentage of block stripes) that are to be assigned to cache memory or the FTL memory. For example, the block stripe resource allocation parameter may indicate for the processing logic to assign a first nine block stripes in the list of block stripes to the cache memory 225 and to assign a tenth block stripe in the list of block stripes to the FTL memory 230. Additionally, or alternatively, the block stripe resource allocation parameter may be based on one or more performance characteristics of the memory device. For example, certain types of memory devices may have larger cache memories than other types of memory devices. Therefore, the block stripe resource allocation parameter may indicate for the processing logic to assign block stripes to the cache memory 225 or the FTL memory 230 based on the performance characteristics of the memory device.

In some aspects, one or more of operations 205, 210, 215, and 220 may be performed per cursor of a plurality of cursors. For example, the processing logic may organize the block stripes in the garbage pool per-cursor, erase the data in the block stripes per-cursor, organize the block stripes based on the PEC count per-cursor, and stage the block stripes per-cursor.

In some aspects, the processing logic may receive a write command (for example, from the host device 120). The processing logic may write data included in the write command to one or more cache memory block stripes and may store the data in the cache memory 225. Additionally, or alternatively, the processing logic may write metadata included in the write command to one or more FTL block stripes and may store the metadata in the FTL memory 230.

As described herein, block stripes can be repurposed between the cache memory 225 and the FTL memory 230. For example, at a first time, the processing logic may stage a non-designated block stripe as a cache memory block stripe based on the block stripe having a lower PEC count than other block stripes in a list of block stripes. At a second time, the data in the cache memory block stripe may become invalid. Therefore, the processing logic may perform garbage collection for the cache memory block stripe and may erase all data in the cache memory block stripe, thereby erasing the designation of the block stripe as a cache memory block stripe. At a third time, the processing logic may sort a plurality of block stripes that includes the non-designated block stripe into a list of block stripes and may stage the block stripe as an FTL block stripe based on the block stripe having a higher PEC count than other block stripes in a list of block stripes.

In some aspects, the processing logic may determine that a PEC count of a block stripe (for example, a cache memory block stripe or an FTL block stripe) has reached a maximum PEC count. The processing logic, based on determining that the PEC count of the block stripe has reached the maximum PEC count, may no longer write to the block stripe, and/or may no longer designate the block stripe as a cache memory block stripe or an FTL block stripe. Additional details describing these features are described below.

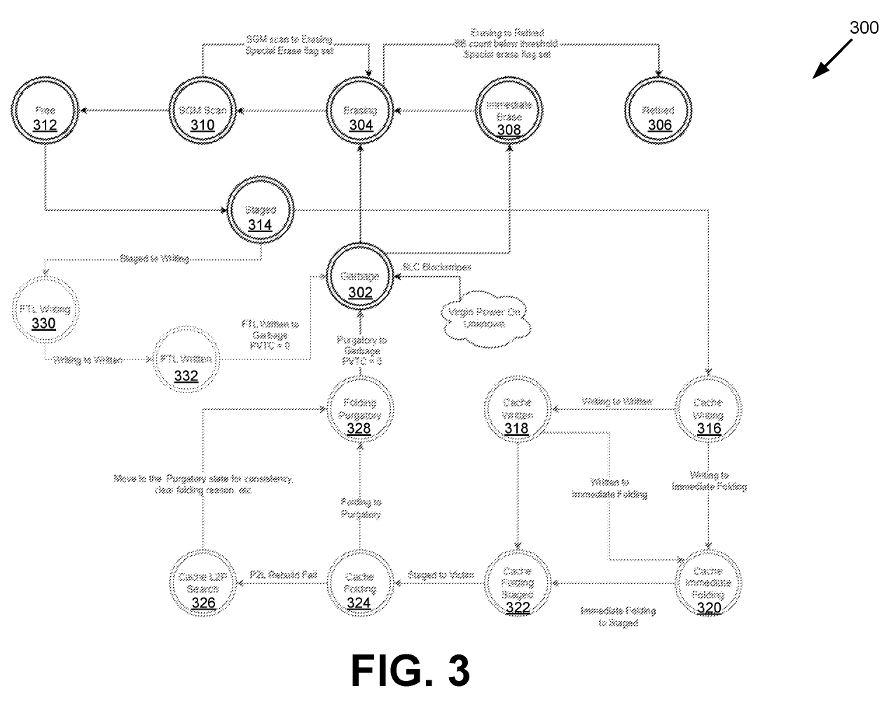

FIG. 3 is a sequence diagram illustrating an example method 300 of programming and erasing block stripes based on block stripe allocations, in accordance with some aspects of the present disclosure. The method 300 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some aspects, the method 300 is performed by the block stripe allocation component 113 of FIG. 1. Although shown in a particular sequence or order, unless otherwise specified, the order of the processes can be modified. Thus, the illustrated aspects should be understood only as examples, and the illustrated processes can be performed in a different order, and some processes can be performed in parallel. Additionally, one or more processes can be omitted in various aspects. Thus, not all processes are required in every aspect. Other process flows are possible.

At operation 302, the processing logic may perform garbage collection for multiple block stripes. The multiple block stripes may be multiple SLC block stripes. In some aspects, the multiple block stripes may include at least one cache memory block stripe and at least one FTL block stripe. For example, the multiple block stripes may include at least one block stripe that is allocated to be used by the cache memory and at least one block stripe that is allocated to be used by the FTL memory. The at least one cache memory block stripe and the at least one FTL block stripe may share a common garbage pool. Therefore, the garbage collection process performed by the processing logic may be the same for the cache memory block stripes and the FTL block stripes. In some other aspects, the multiple block stripes may include one or more other types of block stripes (for example, triple-layer cell (TLC) block stripes).

At operation 304, the processing logic may erase all data in the block stripes. Erasing the data in the block stripes may remove the designation of the block stripes as cache memory block stripes or FTL block stripes. For example, erasing data in six cache memory block stripes and two FTL block stripes may result in eight non-designated block stripes. At operation 306, the processing logic may retire one or more non-designated block stripes based on the one or more non-designated block stripes having PEC counts that are greater than a maximum PEC count threshold. In some aspects, retiring the one or more non-designated block stripes may include setting a flag indicating that the one or more non-designated block stripes are retired (for example, can no longer be used for performing write operations). At operation 308, the processing logic may perform an erase operation for one or more non-designated block stripes. In some examples, the erase operation may be an immediate erase. An immediate erase is an erase that is to be performed with a certain level of urgency due to one or more system conditions (such as a lack of free block stripes or a reconstruction condition), whereas a standard erase is an erase that is to be performed in accordance with a scheduling operation, for example, in order to satisfy a free block stripe threshold. At operation 310, the processing logic may perform a select gate maintenance (SGM) scan to erase data in one or more non-designated block stripes. In some aspects, the processing logic may set a flag (e.g., a special erase flag) associated with the one or more non-designated block stripes indicating that the SGM scan has been performed for the one or more non-designated block stripes. At operation 312, the processing logic may organize the non-designated block stripes in a free pool. The free pool may include multiple non-designated block stripes that can be allocated to various types of memory, such as cache memory or FTL memory.

At operation 314, the processing logic may stage one or more block stripes of the multiple block stripes in the free pool. Staging the one or more block stripes from the free pool may include assigning the one or more block stripes from the free pool to the cache memory or the FTL memory. For example, staging the block stripes may include designating a first block stripe as a cache memory block stripe based on the block stripe having a lower PEC count and designating a second block stripe as an FTL block stripe based on the block stripe having a higher PEC count. In some aspects, the free pool may include multiple non-designated block stripes that are organized based on respective PEC counts of the non-designated block stripes. For example, the non-designated block stripes in the free pool may be organized in a list ranging from block stripes having the lowest PEC count to block stripes having the highest PEC count. The processing logic may select a first candidate block stripe (or multiple first candidate block stripes) from the free pool having the lowest PEC count may assign the first candidate block stripe(s) to the cache memory. Additionally, or alternatively, the processing logic may select a second candidate block stripe (or multiple second candidate block stripes) from the free pool having the second lowest PEC count in the list of block stripes and may assign the second candidate block stripe(s) to the FTL memory.

In some aspects, the processing logic may stage the block stripes using a block stripe resource allocation parameter. The block stripe resource allocation parameter may indicate a quantity of block stripes (or a percentage of block stripes) that are to be assigned to cache memory or the FTL memory. For example, the block stripe resource allocation parameter may indicate for the processing logic to assign a first four block stripes in the list of block stripes to the cache memory and to assign a fifth block stripe in the list of block stripes to the FTL memory. Additionally, or alternatively, the block stripe resource allocation parameter may be based on one or more performance characteristics of the memory device (as described above).

At operation 316, the processing logic may perform a cache write. The processing logic may perform the cache write using one or more block stripes that are allocated to the cache memory. For example, the processing logic may receive a write command from a host device and may write data to the cache memory using one or more block stripes that are designated as cache memory block stripes. At operation 318, the processing logic may complete the cache write operation. The cache write operation may be complete when data included in the write command has been written to the one or more cache memory block stripes. At operation 320, the processing logic may perform an immediate folding for the data in the cache. In some aspects, the processing logic may perform the immediate folding while the data is being written to the cache (for example, concurrently with writing the data to the cache). In some other aspects, the processing logic may perform the immediate folding after the data has been written to the cache.

At operation 322, the processing logic may stage one or more blocks stripes for cache folding. In some aspects, the processing logic may stage the block stripes for the cache folding after the data has been written to the cache memory (e.g., without performing the immediate folding). In some other aspects, the processing logic may stage the block stripes for the cache folding after performing the cache immediate folding is complete. At operation 324, the processing logic may perform the cache folding. The processing logic may perform the cache folding based on one or more blocks in the block stripes having invalid data. At operation 326, the processing logic may perform a cache logical-to-physical (L2P) search. Performing the cache L2P search may include searching an L2P mapping table for errors between a logical address of the data in the cache and a physical address of the data in the cache. At operation 328, the processing logic may move one or more cache memory block stripes to purgatory. Purgatory may be a state of a block stripe indicating that the block stripe is ready for garbage collection. Block stripes indicated as being in purgatory may not be used for write operations (or any other memory device operations). Subsequently, the processing logic may perform garbage collection for the block stripes (as described in connection with operation 302).

At operation 330, the processing logic may perform an FTL write. The processing logic may perform the FTL write using one or more block stripes that are allocated to the FTL memory. For example, the processing logic may receive a write command from a host device and may write metadata to the FTL memory using one or more block stripes that are designated as FTL block stripes. At operation 332, the processing logic may complete the FTL write. Subsequently, the processing logic may detect that data in one or more FTL block stripes is invalid and may perform garbage collection for the one or more FTL block stripes (as described in connection with operation 302).

As described herein, the FTL and cache bands may have a dedicated number of candidate block stripes in the free pool. In some aspects, an erase may be initiated when a number of free candidate block stripes falls below a threshold. An erase context may be used to maintain a record of block stripe identifiers that are being erased per band. Once the erase is complete, the candidate may be moved to the free pool. The free pool may maintain a counter for each band. When a candidate needs to be staged, additional logic may be executed. For example, the free pool per band counter is not to be zero. If staging is needed for the cache band, then the free counter for the cache band must be greater than zero. The candidate with the minimum PEC count in the free pool may be allocated to the cache band and the candidate with the second lowest PEC count is to be allocated to the FTL band. In some aspects, when a candidate is staged, a message containing the block stripe identifier may be provided. Therefore, a shared staged pool may be adequate for both the cache band and the FTL band.

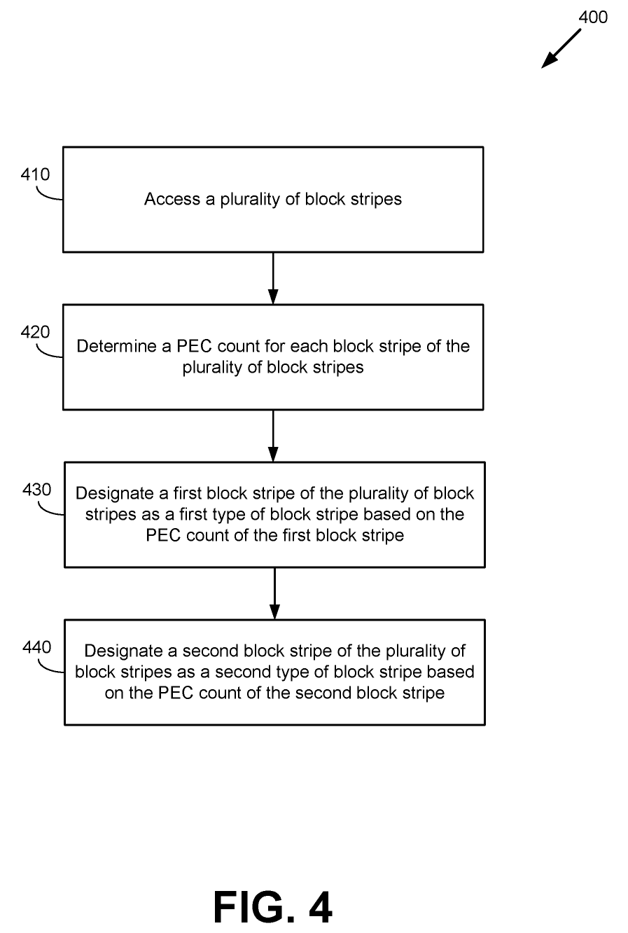

FIG. 4 is a flow diagram of an example method of allocating block stripes based on program erase cycles, in accordance with some aspects of the present disclosure. The method 400 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some aspects, the method 400 is performed by the block stripe allocation component 113 of FIG. 1. Although shown in a particular sequence or order, unless otherwise specified, the order of the processes can be modified. Thus, the illustrated aspects should be understood only as examples, and the illustrated processes can be performed in a different order, and some processes can be performed in parallel. Additionally, one or more processes can be omitted in various aspects. Thus, not all processes are required in every aspect. Other process flows are possible.

At operation 410, the processing logic accesses a plurality of block stripes. Each block stripe of the plurality of block stripes spans a plurality of dies of a memory device. Each block stripe of the plurality of block stripes does not include any valid data.

At operation 420, the processing logic determines a program erase cycle count for each block stripe of the plurality of block stripes.

At operation 430, the processing logic designates a first block stripe of the plurality of block stripes as a first type of block stripe based on a corresponding program erase cycle count of the first block stripe.

At operation 440, the processing logic designates a second block stripe of the plurality of block stripes as a second type of block stripe based on a corresponding program erase cycle count of the second block stripe. The corresponding program erase cycle count of the second block stripe is greater than the corresponding program erase cycle count of the first block stripe.

In some implementations, the first type of block stripe is programmed by a processing device more frequently than the second type of block stripe. In some implementations, the first type of block stripe is a cache memory block stripe and the second type of block stripe is a flash translation layer block stripe.

In some implementations, designating the first block stripe as the first type of block stripe comprises setting a flag associated with the first block stripe to a first value, and designating the second block stripe as the second type of block stripe comprises setting a flag associated with the second block stripe to a second value.

In some implementations, the processing logic sorts the plurality of block stripes into a list of block stripes ordered from a lowest program erase cycle count of the plurality of block stripes to a highest program erase cycle count of the plurality of block stripes. In some implementations, designating the first block stripe as the first type of block stripe comprises designating a first quantity of block stripes from the list of block stripes as cache memory block stripes, and designating the second block stripe as the second type of block stripe comprises designating a second quantity of block stripes in the list of block stripes as flash translation layer block stripes. The first quantity of block stripes and the second quantity of block stripes are based on a block stripe resource allocation parameter associated with the memory device.

In some implementations, the processing logic performs a garbage collection process for one or more block stripes of the plurality of block stripes and erases data in each block stripe of the one or more block stripes based on a result of the garbage collection process. Erasing the data in each block stripe of the one or more block stripes comprises erasing the designation of the block stripe as the first type of block stripe or the second type of block stripe.

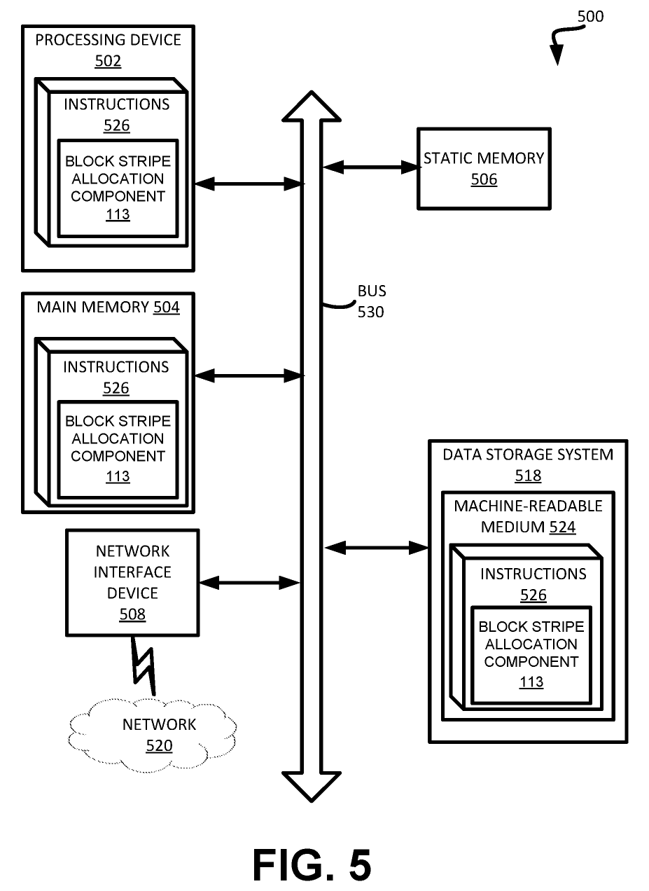

FIG. 5 illustrates an example machine of a computer system 500 within which a set of instructions, for causing the machine to perform any one or more of the methodologies discussed herein, can be executed. In some aspects, the computer system 500 can correspond to a host system (e.g., the host system 120 of FIG. 1) that includes, is coupled to, or utilizes a memory sub-system (e.g., the memory sub-system 110 of FIG. 1) or can be used to perform the operations of a controller (e.g., to execute an operating system to perform operations corresponding to the block stripe allocation component 113 of FIG. 1). In alternative aspects, the machine can be connected (e.g., networked) to other machines in a LAN, an intranet, an extranet, and/or the Internet. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 500 includes a processing device 502, a main memory 504 (e.g., read-only memory (ROM), flash memory, dynamic random access memory (DRAM) such as synchronous DRAM (SDRAM) or Rambus DRAM (RDRAM), etc.), a static memory 506 (e.g., flash memory, static random access memory (SRAM), etc.), and a data storage system 518, which communicate with each other via a bus 530.

Processing device 502 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 502 can also be one or more special-purpose processing devices such as an application specific integrated circuit (ASIC), a field programmable gate array (FPGA), a digital signal processor (DSP), network processor, or the like. The processing device 502 is configured to execute instructions 526 for performing the operations and steps discussed herein. The computer system 500 can further include a network interface device 508 to communicate over the network 520.

The data storage system 518 can include a machine-readable storage medium 524 (also known as a computer-readable medium) on which is stored one or more sets of instructions 526 or software embodying any one or more of the methodologies or functions described herein. The instructions 526 can also reside, completely or at least partially, within the main memory 504 and/or within the processing device 502 during execution thereof by the computer system 500, the main memory 504 and the processing device 502 also constituting machine-readable storage media. The machine-readable storage medium 524, data storage system 518, and/or main memory 504 can correspond to the memory sub-system 110 of FIG. 1.

In some aspects, the instructions 526 include instructions to implement functionality corresponding to the sequential write component 113 of FIG. 1). While the machine-readable storage medium 524 is shown in an example aspect to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, which manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general purpose computer selectively activated or reconfigured by a computer program stored in the computer. Such a computer program can be stored in a computer readable storage medium, such as any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, which can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some aspects, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

In the foregoing specification, aspects of the disclosure have been described with reference to specific example aspects thereof. It will be evident that various modifications can be made thereto without departing from the broader spirit and scope of aspects of the disclosure as set forth in the following claims. The specification and drawings are, accordingly, to be regarded in an illustrative sense rather than a restrictive sense.

What is claimed is:

1. A system comprising:
a memory device comprising a plurality of dies; and
a processing device, coupled with the memory device, configured to perform operations comprising:
accessing a plurality of block stripes, each block stripe of the plurality of block stripes spanning the plurality of dies of the memory device, wherein each block stripe of the plurality of block stripes does not include any valid data;
determining a program erase cycle count for each block stripe of the plurality of block stripes;
designating a first block stripe of the plurality of block stripes as a cache memory block stripe based on a corresponding program erase cycle count of the first block stripe; and
designating a second block stripe of the plurality of block stripes as a flash translation layer block stripe based on a corresponding program erase cycle count of the second block stripe, wherein the corresponding program erase cycle count of the second block stripe is greater than the corresponding program erase cycle count of the first block stripe.

2. The system of claim 1, wherein designating the first block stripe as the cache memory block stripe comprises setting a flag associated with the first block stripe to a first value, and wherein designating the second block stripe as the flash translation layer block stripe comprises setting a flag associated with the second block stripe to a second value.

3. The system of claim 1, wherein the processing device is further configured to perform operations comprising sorting the plurality of block stripes into a list of block stripes ordered from a lowest program erase cycle count of the plurality of block stripes to a highest program erase cycle count of the plurality of block stripes.

4. The system of claim 3, wherein designating the first block stripe as the cache memory block stripe comprises designating a first quantity of block stripes from the list of block stripes as cache memory block stripes, and wherein designating the second block stripe as the flash translation layer block stripe comprises designating a second quantity of block stripes in the list of block stripes as flash translation layer block stripes, wherein the first quantity of block stripes and the second quantity of block stripes are based on a block stripe resource allocation parameter associated with the memory device.

5. The system of claim 1, wherein the processing device is further configured to perform operations comprising:
performing a garbage collection process for one or more block stripes of the plurality of block stripes; and
erasing data in each block stripe of the one or more block stripes based on a result of the garbage collection process, wherein erasing the data in each block stripe of the one or more block stripes comprises erasing the designation of the block stripe as the cache memory block stripe or the flash translation layer block stripe.

6. The system of claim 5, wherein the one or more block stripes are included in a common garbage pool that includes at least one cache memory block stripe and at least one flash translation layer block stripe, wherein the at least one cache memory block stripe and the at least one flash translation layer block stripe do not include any valid data.

7. The system of claim 1, wherein the processing device is further configured to perform operations comprising:
receiving a write command from a host device; and
performing at least one of:
writing data included in the write command to the cache memory block stripe; or
writing metadata associated with the data to the flash translation layer block stripe.

8. A method comprising:
accessing a plurality of block stripes, each block stripe of the plurality of block stripes spanning a plurality of dies of a memory device, wherein each block stripe of the plurality of block stripes does not include any valid data;
determining a program erase cycle count for each block stripe of the plurality of block stripes;
designating a first block stripe of the plurality of block stripes as a first type of block stripe based on a corresponding program erase cycle count of the first block stripe; and
designating a second block stripe of the plurality of block stripes as a second type of block stripe based on a corresponding program erase cycle count of the second block stripe, wherein the corresponding program erase cycle count of the second block stripe is greater than the corresponding program erase cycle count of the first block stripe.

9. The method of claim 8, wherein the first type of block stripe is programmed by a processing device more frequently than the second type of block stripe.

10. The method of claim 8, wherein the first type of block stripe is a cache memory block stripe and the second type of block stripe is a flash translation layer block stripe.

11. The method of claim 8, wherein designating the first block stripe as the first type of block stripe comprises setting a flag associated with the first block stripe to a first value, and wherein designating the second block stripe as the second type of block stripe comprises setting a flag associated with the second block stripe to a second value.

12. The method of claim 8, further comprising sorting the plurality of block stripes into a list of block stripes ordered from a lowest program erase cycle count of the plurality of block stripes to a highest program erase cycle count of the plurality of block stripes.

13. The method of claim 12, wherein designating the first block stripe as the first type of block stripe comprises designating a first quantity of block stripes from the list of block stripes as cache memory block stripes, and wherein designating the second block stripe as the second type of block stripe comprises designating a second quantity of block stripes in the list of block stripes as flash translation layer block stripes, wherein the first quantity of block stripes and the second quantity of block stripes are based on a block stripe resource allocation parameter associated with the memory device.

14. The method of claim 8, further comprising:
performing a garbage collection process for one or more block stripes of the plurality of block stripes; and
erasing data in each block stripe of the one or more block stripes based on a result of the garbage collection process, wherein erasing the data in each block stripe of the one or more block stripes comprises erasing the designation of the block stripe as the first type of block stripe or the second type of block stripe.

15. The method of claim 14, wherein the one or more block stripes are included in a common garbage pool that includes at least one first type of block stripe and at least one second type of block stripe, wherein the at least one first type of block stripe and the at least one second type of block stripe do not include any valid data.

16. A non-transitory computer-readable storage medium comprising instructions that, when executed by a processing device, cause the processing device to perform operations comprising:
accessing a plurality of block stripes, each block stripe of the plurality of block stripes spanning a plurality of dies of a memory device, wherein each block stripe of the plurality of block stripes does not include any valid data;
determining a program erase cycle count for each block stripe of the plurality of block stripes;
designating a first block stripe of the plurality of block stripes as a cache memory block stripe based on a corresponding program erase cycle count of the first block stripe; and
designating a second block stripe of the plurality of block stripes as a flash translation layer block stripe based on a corresponding program erase cycle count of the second block stripe, wherein the corresponding program erase cycle count of the second block stripe is greater than the corresponding program erase cycle count of the first block stripe.

17. The non-transitory computer-readable storage medium of claim 16, wherein designating the first block stripe as the cache memory block stripe comprises setting a flag associated with the first block stripe to a first value, and wherein designating the second block stripe as the flash translation layer block stripe comprises setting a flag associated with the second block stripe to a second value.

18. The non-transitory computer-readable storage medium of claim 16, wherein the instructions, when executed by the processing device, further cause the processing device to perform operations comprising sorting the plurality of block stripes into a list of block stripes ordered from a lowest program erase cycle count of the plurality of block stripes to a highest program erase cycle count of the plurality of block stripes.

19. The non-transitory computer-readable storage medium of claim 18, wherein designating the first block stripe as the cache memory block stripe comprises designating a first quantity of block stripes from the list of block stripes as cache memory block stripes, and wherein designating the second block stripe as the flash translation layer block stripe comprises designating a second quantity of block stripes in the list of block stripes as flash translation layer block stripes, wherein the first quantity of block stripes and the second quantity of block stripes are based on a block stripe resource allocation parameter associated with the memory device.

20. The non-transitory computer-readable storage medium of claim 16, wherein the instructions, when executed by the processing device, further cause the processing device to perform operations comprising:
performing a garbage collection process for one or more block stripes of the plurality of block stripes; and
erasing data in each block stripe of the one or more block stripes based on a result of the garbage collection process, wherein erasing the data in each block stripe of the one or more block stripes comprises erasing the designation of the block stripe as the cache memory block stripe or the flash translation layer block stripe.
